(19) United States
(12) Patent Application Publication
(10) Pub. No.: US 2026/0084078 A1
(43) Pub. Date: Mar. 26, 2026

(54) SUSCEPTOR HEAT INDUCTION FOR WATER-OIL SEPARATION

(71) Applicant: Saudi Arabian Oil Company, Dhahran (SA)

(72) Inventors: Maher Maqbool Shariff, Dhahran (SA); Hassan A. Aljama, Al-Qatif (SA)

(21) Appl. No.: 18/897,118

(22) Filed: Sep. 26, 2024

(51) Int. Cl. B01D 17/04; C02F 1/02; C02F 1/40; C02F 101/32; C02F 103/10; H05B 6/10

(52) U.S. Cl. CPC B01D 17/042; C02F 1/02; C02F 1/40; H05B 6/108; C02F 2101/32; C02F 2103/10

(57) ABSTRACT

Systems and methods for breaking a water and oil emulsion. The systems include a vessel configured to receive an oil and water emulsion, a susceptor, a conducting element coiled around the vessel, and a source of alternating current configured to flow alternating current through the conducting element. The flow of alternating current creates an alternating magnetic field, heating the susceptor.

### TECHNICAL FIELD

This document relates to methods and compositions used in treating subterranean formations for enhancing hydrocarbon fluid recovery.

### BACKGROUND

Produced oil is dewatered before pipeline transportation. However, the water can be difficult to separate, because of the inherent surface-active materials present in the oil, coupled with the production operating conditions. Thus, the separation of water from tight emulsions in produced oil is an important process in oil production.

### SUMMARY

This disclosure describes methods and systems for the efficient separation of oil and water from an oil and water emulsion.

In some embodiments, an induction heating system for breaking an oil and water emulsion includes a vessel configured to receive an oil and water emulsion, a susceptor disposed inside the vessel, a conducting element coiled around the outside of the vessel, a source of alternating current configured to flow alternating current through the conducting element, a first outlet configured to flow oil from the vessel and a second outlet configured to flow water from the vessel.

In some embodiments, an induction heating system includes a susceptor layer configured to surround a crude oil stream, a conducting element coiled around the outside of the susceptor layer, and an alternating current source configured to flow alternating current through the conducting element.

In some embodiments, a method for separating oil and water from an oil and water emulsion includes flowing an emulsion of oil and water into an induction heating system, wherein the induction heating system includes a vessel configured to receive the oil and water emulsion, a susceptor disposed inside the vessel, a conducting element coiled around the outside of the vessel, and a source of alternating current configured to flow alternating current through the conducting element. The method includes flowing alternating current through the conducting element to generate an alternating magnetic field, wherein the alternating magnetic field heats the susceptor, and transferring heat from the susceptor to the oil and water emulsion.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is a schematic of an example gas-oil separation plant (GOSP).

FIG. 2 is an example schematic of an embodiment of an induction heating system including a susceptor.

FIG. 3 is an example schematic of an embodiment of an induction heating system including a susceptor.

FIG. 4 is an example schematic of an embodiment of an induction heating system including a susceptor.

FIG. 5 is an example schematic of an embodiment of an induction heating system including a susceptor.

FIG. 6 is an example schematic of a pressurized production trap that includes an upstream induction heating system.

FIG. 7 is a flowchart of an example method of separating oil and water from an oil and water emulsion.

FIG. 8 is a flow chart of an example method for heating an oil and water emulsion.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are methods and systems for the efficient separation of oil and water from an oil and water emulsion. For example, the methods and systems can be used to break an oil and water emulsion present in a crude gas stream or produced oil.

The methods and systems include a susceptor. A susceptor is capable of being heated by induction, and conducting the energy to the work material, for example, an oil and water emulsion. Susceptors include silicon carbide, molybdenum, graphite, aluminum, carbon steel, copper, stainless steels, and other electrically conductive materials. In some embodiments, a susceptor is made from graphite. Graphite is highly resistive and very machinable. In addition, graphite can withstand temperatures up to 3000° C.

The susceptor is part of an induction heater system. The system includes a conducting element. In some embodiments, the conducting element includes silver, copper, gold, aluminum, zinc, nickel, brass, bronze, iron, platinum, carbon steel, stainless steel, or lead, or any combination thereof. The induction heater supplies an alternating current (A/C) which in turn generates a magnetic field with a resonating eddy current. The resonating eddy current heats the susceptor. The induction heater can be configured to be in close proximity to or surrounding a vessel. The vessel includes a susceptor. In some embodiments, the susceptor is inside the vessel. In some embodiments, the susceptor is outside the vessel. The vessel is configured to receive an oil and water emulsion. In some embodiments, the vessel is part of a gas-oil separation plant (GOSP). In some embodiments, the vessel is a production trap, for example a pressurized production trap. Production traps include three-phase and two-phase gravity separators. A three-phase gravity separator separates crude oil, where the crude oil includes gas, oil, and water mixed forming a continuum. A two-phase gravity separator separates a mixture of oil and water. Oil and water are immiscible fluids and will separate due to gravity. The denser liquid, water, settles at the bottom of the separation trap, whereas the lighter liquid, oil, rises to the top. In some embodiments, the crude oil enters a vessel or production trap at a high pressure directly from production wells. In some embodiments, the pressure in the vessel or production trap can be up to 150 psi (1030 kPa).

In heat exchanger design, there is an abundance of examples demonstrating temperature increment, ΔT on the coefficient of performance (COP) in optimizing heat exchangers design. The higher the ΔT is the more effective is the energy transportation for required heating. Cost effectiveness is of paramount importance. Induction heating is an inexpensive and reliable source of producing energy in the form of heat. The induction heater system including a susceptor can be placed in different stages of a crude oil treatment facility. For example, the susceptor can be placed inside multiphase separation vessels, or upstream of a separation vessel, or any combination thereof.

An induction heater that includes a susceptor is an efficient way to break an oil and water emulsion. The susceptor can be placed in a crude oil stream or a vessel to provide a uniform heating to the crude oil. In other words, the system provides electrical energy in the form of heat that utilizes the technology of heating through a susceptor. In addition, an induction heater that includes a susceptor promotes the breakage of water/oil emulsions via heating and efficiently separates the two phases. Further, the systems and method described herein reduce the reliance on chemical demulsifiers that are typically used to enhance water/oil separation, and reduce the carbon footprint of emulsion separation by using a non-fossil fuel resource as the source of heat induction.

Compared to conventional furnaces, induction heating systems that include a susceptor have several advantages. For example, the induction heating systems have much shorter heating times, minimizing scaling and oxidation of the system. Scaling, fouling and oxidation are associated with the quality of crude oil flowing into the pressurized traps. The water in the crude oil can be brackish, containing amounts of salts. The ambient outdoor temperature during crude oil production can also affect scaling and oxidation. Further, the handling time of the equipment, i.e., the duration the crude oil is in contact with process equipment can affect scaling and oxidation. Accordingly, a system with reduced heating times is advantageous.

The induction heating systems also allow for more accurate temperature control, allowing efficient heating but also able to prevent overheating by tight control of the temperature using the alternating current. Unlike furnaces which have to ramp up the required temperature, the induction heating system reaches the target temperature at a fast rate. Accordingly, there is no time lost waiting for a furnace to heat up. In addition, the induction heating systems can be automated, minimizing manual labor.

Another advantage is that the heat can be directed to a specific point, which is important for parts with only one forming area. This also results in greater thermal efficiency, as the heat is generated in the susceptor itself and does not need to be heated in a large chamber.

The induction heating systems including a susceptor can be used in gas-oil separation plants (GOSPs). The inducing heating systems deploy heat to destabilize the interfacial film of a water and oil emulsion. The applied heat destabilizes water droplets in the oil and water emulsion, thus promoting settling due to the density difference between the oil and water.

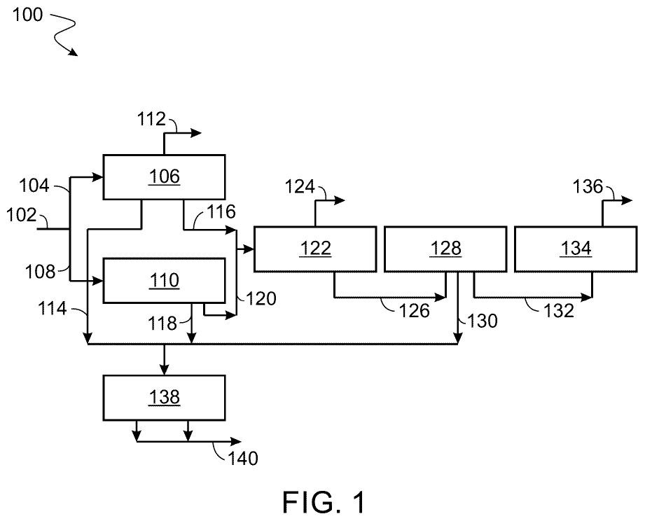

FIG. 1 is a schematic of an example gas-oil separation plant (GOSP) 100. A production header 102 provides a first stream of crude oil 104 to a high pressure production trap 106, and a second stream of crude oil 108 to a low pressure production trap 110. The high pressure production trap 106 is a three-phase vessel and separates the first stream of crude oil 104 into a high pressure gas 112, a first water stream 114, and a first oil stream 116. The low pressure production trap 110 is a two-phase vessel and separates the second crude oil stream 108 into a second water stream 118 and a second oil stream 120. The first oil stream 116 and the second oil stream 120 are combined and directed to a second low pressure production trap 122. The second low pressure production trap 122 separates the combined oil streams into a low pressure gas stream 124 and a third oil stream 126. The third oil stream 126 is directed to a dehydrator 128. The dehydrator 128 separates the third oil stream into a third water stream 130 and a dehydrated oil stream 132. The dehydrated oil stream 132 is directed to a desalter 134. The desalter 134 removes salt from the dehydrated oil stream to yield a dry oil stream 136. The dry oil stream can then be sold, utilized, or processed further. The first water stream 114, second water stream 118, and third water stream 130 are combined and directed to a water oil separator 138. The water oil separator 138 yields a produced water stream 140. The produced water stream can be further utilized, for example, as a produced water injection in a drilling operation. The induction heating systems including a susceptor described herein can be utilized at one or more points in the example GOSP of FIG. 1. For example, the induction heating systems described herein can be utilized in the high pressure trap 106, the low pressure production trap 110, in the dehydrator 128, upstream of the high pressure trap 106, upstream of the low pressure production trap 110, upstream of the dehydrator 128, at or along the production header 102, or at any combination thereof.

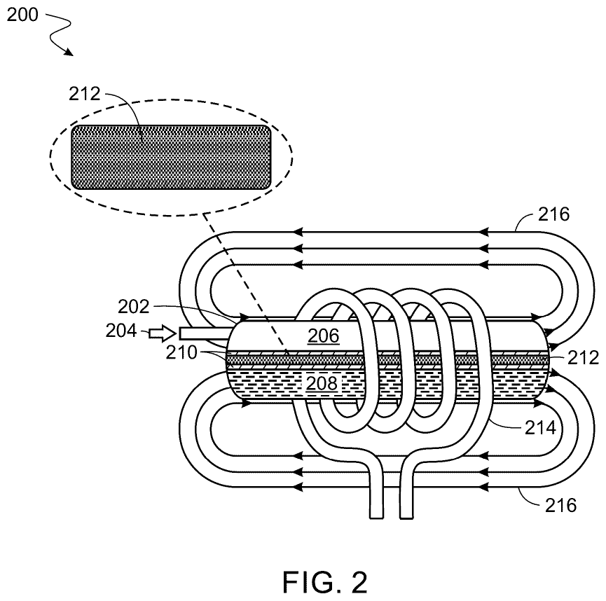

FIG. 2 is an example schematic of an embodiment of an induction heating system including a susceptor 200. The induction heating system 200 includes a pressurized production trap 202 configured to receive a crude oil stream 204. The crude oil stream includes oil and water. In the pressurized production trap 202, the oil layer 206 and the water layer 208 partially separate, leaving an emulsion layer 210. The pressurized production trap 202 includes a susceptor 212. The susceptor is hinged to the walls of the production trap, mounted via fixtures configured to keep the susceptor from moving or wobbling. The susceptor does not move inside the vessel. In some embodiments, the susceptor 212 is positioned inside the pressurized production trap 202 such that it is submerged in the emulsion layer 210. The emulsion layer can flow freely through the susceptor, for example, via holes or perforations in the susceptor. The holes and perforations ensure that each phase (i.e., the oil phase and the water phase) will find a path to flow upward or downward within the vessel. The holes or perforations ensure that neither phase becomes trapped above or below a horizontally oriented susceptor. The induction heating system includes a conducting element 214 that is positioned around the pressurized production trap 202. In some embodiments, the conducting element 214 is coiled around the pressurized production trap 202. The conducting element 214 is connected to an alternating current source. As the alternating current flows through the conducting element 214, an alternating magnetic field 216 is generated around the pressurized production trap 202. The alternating magnetic field 216 induces heat in the susceptor 212. Heat in the susceptor is transferred to the water/oil emulsion in the production trap 202 and facilitates the separation of the oil and water layers. The oil and water layers can exit the production trap through separate outlets, for example an outlet at the top of the production trap configured to flow the oil from the production trap, and an outlet at the bottom of the production trap configured to flow the water from the production trap.

In the embodiment shown in FIG. 2, the susceptor is a fixed heating susceptor. The susceptor material is heated by an induction heater. In response to the heating, the temperature of the emulsion layer rises to the specified value, heating up the emulsion layer and easing down the tightness of the emulsion layer, thus separating the oil and water. This improves the breaking of the emulsion layer, separating it to two distinct phases.

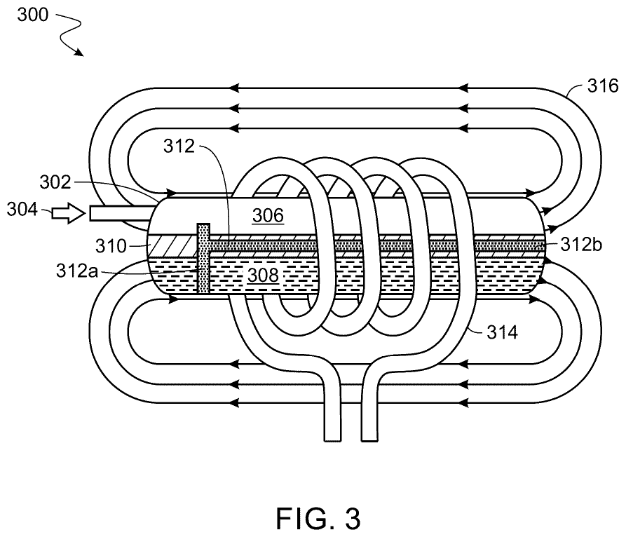

FIG. 3 is an example schematic of an embodiment of an induction heating system including a susceptor 300. The induction heating system 300 includes a pressurized production trap 302 configured to receive a crude oil stream 304. The crude oil stream includes oil and water. In the pressurized production trap 302, the oil layer 306 and the water layer 308 partially separate, leaving an emulsion layer 310. The pressurized production trap 302 includes a susceptor 312. In some embodiments, the susceptor 312 includes a vertical weir 312a and a horizontal section 312b. The vertical weir 312a and horizontal section 312b both include the susceptor material. The vertical weir and the horizontal section are joined together. The horizontal section is positioned inside the pressurized production trap 302 such that it is submerged in the emulsion layer 310. The vertical weir extends from the bottom of the production trap 302, through the emulsion layer 310, and into the oil layer 306. In some embodiments, the emulsion layer can flow freely through the susceptor, for example, via holes or perforations in the susceptor. The vertical weir section of the susceptor is affixed to the bottom of the pressurized production trap. The vertical weir splits the vessel into two regions. The region upstream to the vertical weir is designated for collecting water. The water gets collected in its base and flows out of the vessel through a drainage, referred to as a “water outlet”. The region upstream to the vertical weir allows the lighter density liquid (oil) to gather above the higher density liquid (water) and flow over the weir to the next region downstream of the weir. The water flowing downstream to the weir gets collected in its base and flows out of the vessel. The oil flows out of the vessel through a drainage, referred to as an “oil outlet”. The induction heating system includes a conducting element 314 that is positioned around the pressurized production trap 302. In some embodiments, the conducting element 314 is coiled around the pressurized production trap 302. The conducting element 314 is connected to an alternating current source. As the alternating current flows through the conducting element 314, an alternating magnetic field 316 is generated around the pressurized production trap 302. The alternating magnetic field 316 induces heat in the susceptor 312. Heat in the susceptor is transferred to the water/oil emulsion in the production trap 302 and facilitates the separation of the oil and water layers. The oil and water layers can exit the production trap through separate outlets, for example at outlet at the top of the production trap configured to flow the oil from the production trap, and an outlet at the bottom of the production trap configured to flow the water from the production trap.

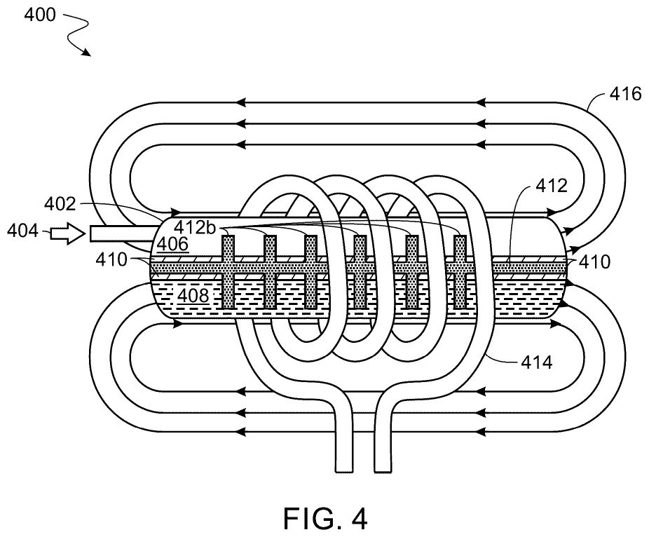

FIG. 4 is an example schematic of an embodiment of an induction heating system including a susceptor 400. The induction heating system 400 includes a pressurized production trap 402 configured to receive a crude oil stream 404. The crude oil stream includes oil and water. In the pressurized production trap 402, the oil layer 406 and the water layer 408 partially separate, leaving an emulsion layer 410. The pressurized production trap 402 includes a susceptor 412. In some embodiments, the susceptor 412 includes a horizontal section 412a and a series of vertical baffles 412b. The horizontal section and vertical baffles are joined together. The horizontal section 412a and the baffles 412b include susceptor material. The horizontal section 412a is positioned inside the pressurized production trap 402 such that it is submerged in the emulsion layer 410. The baffles 412b extend into the water layer 408, through the emulsion layer 410, and into the oil layer 406. The baffles are affixed to the bottom of the production trap 402. The emulsion layer can flow freely through the susceptor, for example, via holes or perforations in the susceptor. The baffles are flow stabilizers. The baffles reduce the flow disturbance in the production trap and promote settling time. The baffles stabilize the fluid flow in the production trap. The more the fluid is stable, the faster the separation of each immiscible phases due to gravity. The induction heating system includes a conducting element 414 that is positioned around the pressurized production trap 402. In some embodiments, the conducting element 414 is coiled around the pressurized production trap 402. The conducting element 414 is connected to an alternating current source. As the alternating current flows through the conducting element 414, an alternating magnetic field 416 is generated around the pressurized production trap 402. The alternating magnetic field 416 induces heat in the susceptor 412. Heat in the susceptor is transferred to the water/oil emulsion in the production trap 402 and facilitates the separation of the oil and water layers. The oil and water layers can exit the production trap through separate outlets, for example at outlet at the top of the production trap configured to flow the oil from the production trap, and an outlet at the bottom of the production trap configured to flow the water from the production trap.

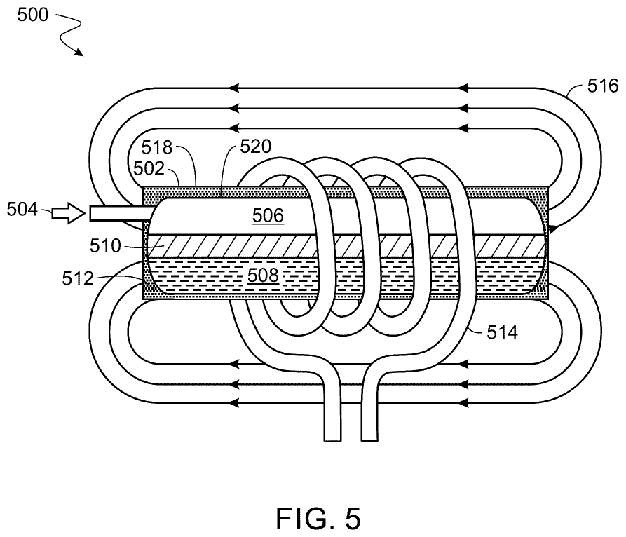

FIG. 5 is an example schematic of an embodiment of an induction heating system including a susceptor 500. The induction heating system 500 includes a pressurized production trap 502 configured to receive a crude oil stream 504. The crude oil stream includes oil and water. The production trap 502 includes an outer wall 518 and an inner wall 520. In the pressurized production trap 502, the oil layer 506 and the water layer 508 partially separate, leaving an emulsion layer 510. The pressurized production trap 502 includes a susceptor 512 between in the outer wall 518 and the inner wall 520 of the production trap 502. The susceptor 512 wraps around the entire inner wall 520 of the production trap 502 such that the interior of the production trap 502 is surrounded by the susceptor 512. The induction heating system includes a conducting element 514 that is positioned around the pressurized production trap 502. In some embodiments, the conducting element 514 is coiled around the pressurized production trap 502. The conducting element 514 is connected to an alternating current source. As the alternating current flows through the conducting element 514, an alternating magnetic field 516 is generated around the pressurized production trap 502. The alternating magnetic field 516 induces heat in the susceptor 512. Heat in the susceptor is transferred to the water/oil emulsion in the production trap 502 and facilitates the separation of the oil and water layers. The heat provided by the surrounding susceptor is uniformly distributed around the pressured production trap. The oil and water layers can exit the production trap through separate outlets, for example at outlet at the top of the production trap configured to flow the oil from the production trap, and an outlet at the bottom of the production trap configured to flow the water from the production trap. In some embodiments, a system includes a susceptor surrounding the production trap, and an internal susceptor, for example the horizontal susceptor, susceptor and vertical weir, or susceptor and vertical baffles as described herein. Combining a susceptor surrounding the production trap and an internal susceptor can increase the amount of heat supplied to an oil and water emulsion.

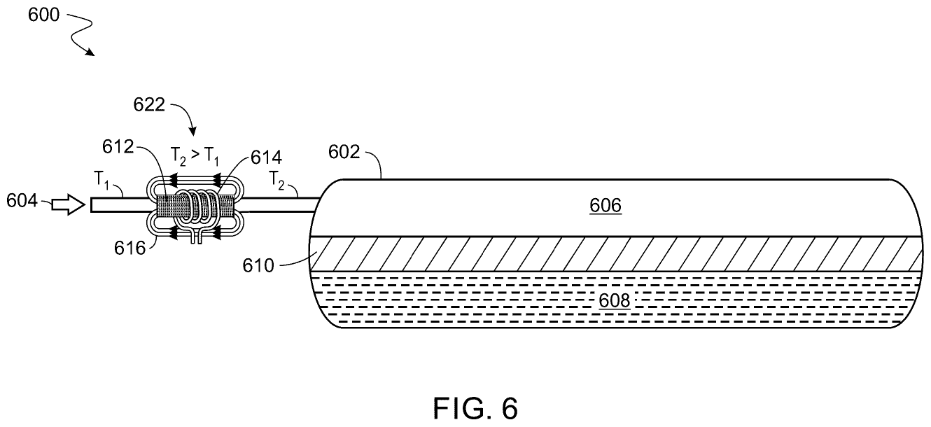

FIG. 6 is an example schematic of a pressurized production trap 602 that includes an upstream induction heating system 622. A crude oil stream 604 passes through the upstream induction heating system 622. The crude oil stream includes oil and water. The system 622 includes a susceptor layer 612 that surrounds the crude oil stream 604. The system 622 further includes a conducting element 614 coiled around the susceptor layer 612. The conducting element 614 is connected to an alternating current source. As the alternating current flows through the conducting element 614, an alternating magnetic field 616 is generated around the susceptor layer 612. The alternating magnetic field 616 induces heat in the susceptor layer 612. Heat in the susceptor layer is transferred to the crude oil stream. Accordingly, the crude oil stream enters the system 622 at a temperature T₁ and exits the system F22 at a higher temperature T₂. The heated crude oil stream flows to a pressurized production trap 602 where the crude oil partially separates into an oil layer 606 and a water layer 608, leaving an emulsion layer 610. Preheating the crude oil increases the efficiency of the oil/gas separation that occurs in the pressurized production trap.

The embodiment shown in FIG. 6 can be used to place an induction heating system including a susceptor upstream of any of the different modules of a GOSP. Alternatively, the embodiment shown in FIG. 6 can be used to retrofit existing GOSP, increasing the efficiency of extant GOSP plants without the need to make internal modifications to any of the production traps or separation vessels. Further, the embodiment shown in FIG. 6 can be used in combination with any of the embodiments shown in FIG. 2 - 5, further improving the efficiency of the oil/gas separation.

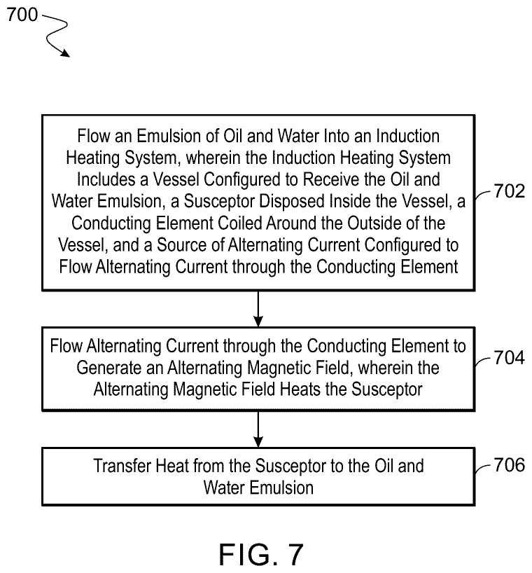

FIG. 7 is a flowchart of an example method 700 of separating oil and water from an oil and water emulsion. At 702, an emulsion of oil and water is flowed into an induction heating system. The induction heating system includes a vessel configured to receive the oil and water emulsion, a susceptor disposed inside the vessel, a conducting element coiled around the outside of the vessel, and a source of alternating current configured to flow alternating current through the conducting element. At 704, alternating current is flowed through the conducting element to generate an alternating magnetic field, wherein the alternating magnetic field heats the susceptor. At 706, heat is transferred from the susceptor to the oil and water emulsion. In some embodiments, the oil is separated from the emulsion, the water is separated from the emulsion, the oil is flowed from the vessel via a first outlet, and the water is flowed from the vessel via a second outlet. In some embodiments, the susceptor includes silicon carbide, molybdenum, graphite, aluminum, carbon steel, copper, stainless steel, an electrically conductive material, or any combination thereof. In some embodiments, the conducting element includes silver, copper, gold, aluminum, zinc, nickel, brass, bronze, iron, platinum, carbon steel, stainless steel, or lead, or any combination thereof.

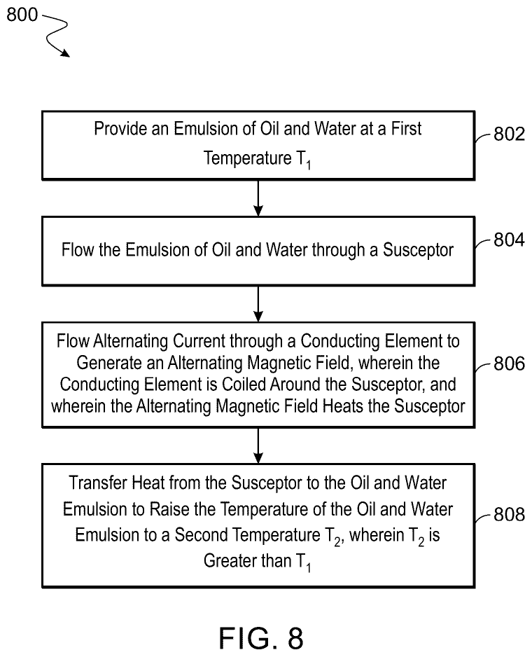

FIG. 8 is a flow chart of an example method 800 for heating an oil and water emulsion. At 802, an emulsion of oil and water is provided at a first temperature T₁. At 804, the emulsion of oil and water is flowed through a susceptor. At 806, alternating current is flowed through a conducting element to generate an alternating magnetic field, wherein the conducting element is coiled around the susceptor, and wherein the alternating magnetic field heats the susceptor. At 808, heat is transferred from the susceptor to the oil and water emulsion to raise the temperature of the oil and water emulsion to a second temperature T₂, wherein T₂ is greater than T₁. In some embodiments, the susceptor includes silicon carbide, molybdenum, graphite, aluminum, carbon steel, copper, stainless steel, an electrically conductive material, or any combination thereof. In some embodiments, the conducting element includes silver, copper, gold, aluminum, zinc, nickel, brass, bronze, iron, platinum, carbon steel, stainless steel, or lead, or any combination thereof. In some embodiments, the method includes treating the oil and water emulsion at the second temperature T₂ in a gas-oil separation plant.

### Embodiments

1. An induction heating system for breaking an oil and water emulsion, the system comprising:
a vessel configured to receive an oil and water emulsion;
a susceptor disposed inside the vessel;
a conducting element coiled around the outside of the vessel;
a source of alternating current configured to flow alternating current through the conducting element;
a first outlet configured to flow oil from the vessel; and
a second outlet configured to flow water from the vessel.

2. The induction heating system of embodiment 1, wherein the vessel is a pressurized production trap.

3. The induction heating system of embodiment 1 or 2, wherein the susceptor is configured to be submerged in an emulsion layer of the oil and water emulsion in the vessel.

4. The induction heating system of any one of embodiments 1-3, wherein the susceptor comprises holes or perforations through the susceptor, configured to allow the oil and water emulsion to flow freely through the susceptor.

5. The induction heating system of any one of embodiments 1-4, wherein the susceptor comprises silicon carbide, molybdenum, graphite, aluminum, carbon steel, copper, stainless steel, an electrically conductive material, or any combination thereof.

6. The induction heating system of any one of embodiments 1-5, wherein the conducting element comprises silver, copper, gold, aluminum, zinc, nickel, brass, bronze, iron, platinum, carbon steel, stainless steel, or lead, or any combination thereof.

7. The induction heating system of any one of embodiments 1-6, wherein the susceptor comprises a vertical weir and a horizontal section, wherein the vertical weir is affixed to the bottom of the vessel.

8. The induction heating system of embodiment 7, wherein the vertical weir is configured to extend from the bottom of the vessel, through an emulsion layer of the oil and water emulsion, and into an oil layer.

9. The induction heating system of any one of embodiments 1-8, wherein the susceptor comprises a plurality of vertical baffles and a horizontal section.

10. The induction heating system of embodiment 9, wherein the vertical baffles are configured to extend into a water layer of the oil and water emulsion, through an emulsion layer of the oil and water emulsion, and into an oil layer of the oil and water emulsion.

11. The induction heating system of any one of embodiments 1-10, wherein the vessel comprises an outer wall and an inner wall, and wherein the susceptor is disposed between the outer wall and the inner wall of the vessel.

12. An induction heating system comprising:
a susceptor layer configured to surround a crude oil stream;
a conducting element coiled around the outside of the susceptor layer; and
an alternating current source configured to flow alternating current through the conducting element.

13. The induction heating system of embodiment 12, wherein the susceptor layer comprises silicon carbide, molybdenum, graphite, aluminum, carbon steel, copper, stainless steel, an electrically conductive material, or any combination thereof.

14. The induction heating system of embodiment 12 or 13, wherein the conducting element comprises silver, copper, gold, aluminum, zinc, nickel, brass, bronze, iron, platinum, carbon steel, stainless steel, or lead, or any combination thereof.

15. The induction heating system of any one of embodiments 12-14, further comprising a pressurized production trap downstream of the susceptor layer and configured to receive the crude oil stream.

16. A method for separating oil and water from an oil and water emulsion, the method comprising:
flowing an emulsion of oil and water into an induction heating system, wherein the induction heating system comprises
   a vessel configured to receive the oil and water emulsion,
   a susceptor disposed inside the vessel,
   a conducting element coiled around the outside of the vessel, and
   a source of alternating current configured to flow alternating current through the conduction element;
flowing alternating current through the conducting element to generate an alternating magnetic field, wherein the alternating magnetic field heats the susceptor; and
transferring heat from the susceptor to the oil and water emulsion.

17. The method of embodiment 16, further comprising:
separating the oil from the oil and water emulsion;
separating the water from the oil and water emulsion;
flowing the oil from the vessel via a first outlet; and
flowing the water from the vessel via a second outlet.

18. The method of embodiment 16 or 17, wherein the susceptor comprises silicon carbide, molybdenum, graphite, aluminum, carbon steel, copper, stainless steel, an electrically conductive material, or any combination thereof.

19. The method of any one of embodiments 16-18, wherein the conducting element comprises silver, copper, gold, aluminum, zinc, nickel, brass, bronze, iron, platinum, carbon steel, stainless steel, or lead, or any combination thereof.

20. The method of any one of embodiments 16-19, further comprising treating the oil from the first outlet, the water from the second outlet, or both in a gas-oil separation plant.

A number of implementations of the disclosure have been described. Nevertheless, it will be understood that various modifications may be made without departing from the spirit and scope of the disclosure.

What is claimed is:

1. An induction heating system for breaking an oil and water emulsion, the system comprising:
a vessel configured to receive an oil and water emulsion;
a susceptor disposed inside the vessel;
a conducting element coiled around the outside of the vessel;
a source of alternating current configured to flow alternating current through the conducting element;
a first outlet configured to flow oil from the vessel; and
a second outlet configured to flow water from the vessel.

2. The induction heating system of claim 1, wherein the vessel is a pressurized production trap.

3. The induction heating system of claim 1, wherein the susceptor is configured to be submerged in an emulsion layer of the oil and water emulsion in the vessel.

4. The induction heating system of claim 1, wherein the susceptor comprises holes or perforations through the susceptor, configured to allow the oil and water emulsion to flow freely through the susceptor.

5. The induction heating system of claim 1, wherein the susceptor comprises silicon carbide, molybdenum, graphite, aluminum, carbon steel, copper, stainless steel, an electrically conductive material, or any combination thereof.

6. The induction heating system of claim 1, wherein the conducting element comprises silver, copper, gold, aluminum, zinc, nickel, brass, bronze, iron, platinum, carbon steel, stainless steel, or lead, or any combination thereof.

7. The induction heating system of claim 1, wherein the susceptor comprises a vertical weir and a horizontal section, wherein the vertical weir is affixed to the bottom of the vessel.

8. The induction heating system of claim 7, wherein the vertical weir is configured to extend from the bottom of the vessel, through an emulsion layer of the oil and water emulsion, and into an oil layer.

9. The induction heating system of claim 1, wherein the susceptor comprises a plurality of vertical baffles and a horizontal section.

10. The induction heating system of claim 9, wherein the vertical baffles are configured to extend into a water layer of the oil and water emulsion, through an emulsion layer of the oil and water emulsion, and into an oil layer of the oil and water emulsion.

11. The induction heating system of claim 1, wherein the vessel comprises an outer wall and an inner wall, and wherein the susceptor is disposed between the outer wall and the inner wall of the vessel.

12. An induction heating system comprising:
a susceptor layer configured to surround a crude oil stream;
a conducting element coiled around the outside of the susceptor layer; and
an alternating current source configured to flow alternating current through the conducting element.

13. The induction heating system of claim 12, wherein the susceptor layer comprises silicon carbide, molybdenum, graphite, aluminum, carbon steel, copper, stainless steel, an electrically conductive material, or any combination thereof.

14. The induction heating system of claim 12, wherein the conducting element comprises silver, copper, gold, aluminum, zinc, nickel, brass, bronze, iron, platinum, carbon steel, stainless steel, or lead, or any combination thereof.

15. The induction heating system of claim 12, further comprising a pressurized production trap downstream of the susceptor layer and configured to receive the crude oil stream.

16. A method for separating oil and water from an oil and water emulsion, the method comprising:
flowing an emulsion of oil and water into an induction heating system, wherein the induction heating system comprises
a vessel configured to receive the oil and water emulsion,
a susceptor disposed inside the vessel,
a conducting element coiled around the outside of the vessel, and
a source of alternating current configured to flow alternating current through the conducting element;
flowing alternating current through the conducting element to generate an alternating magnetic field, wherein the alternating magnetic field heats the susceptor; and
transferring heat from the susceptor to the oil and water emulsion.

17. The method of claim 16, further comprising:
separating the oil from the oil and water emulsion;
separating the water from the oil and water emulsion;
flowing the oil from the vessel via a first outlet; and
flowing the water from the vessel via a second outlet.

18. The method of claim 16, wherein the susceptor comprises silicon carbide, molybdenum, graphite, aluminum, carbon steel, copper, stainless steel, an electrically conductive material, or any combination thereof.

19. The method of claim 16, wherein the conducting element comprises silver, copper, gold, aluminum, zinc, nickel, brass, bronze, iron, platinum, carbon steel, stainless steel, or lead, or any combination thereof.

20. The method of claim 17, further comprising treating the oil from the first outlet, the water from the second outlet, or both in a gas-oil separation plant.
